(19) United States
(12) Patent Application Publication
(10) Pub. No.: US 2014/0062942 A1
(43) Pub. Date: Mar. 6, 2014

(54) Capacitive Touch Pen

(71) Applicant: SHIN HUNG YIH TECHNOLOGY CO., LTD., Taipei City (TW)

(72) Inventor: Yi-Hung Ho, Taipei (TW)

(73) Assignee: SHIN HUNG YIH TECHNOLOGY CO., LTD., TAIPEI CITY (TW)

(21) Appl. No.: 13/712,023

(22) Filed: Dec. 12, 2012

(30) Foreign Application Priority Data
Aug. 30, 2012 (TW) 101216678

(51) Int. Cl. G06F 3/03

(52) U.S. Cl. CPC G06F 3/03
USPC 345/174

(57) ABSTRACT

A capacitive touch pen includes a shaft, and a tip formed of a multilateral elastic conductor and located at the bottom side of the shaft for touching a touch screen to induce a signal. Preferably, the tip has the maximum width in the range of 2.5 mm˜4 mm.

### BACKGROUND OF THE INVENTION

1. Field of the Invention

The present invention relates to touch technology and more particularly, to a capacitive touch pen, which has the tip thereof made of a multilateral elastic conductor that facilitates writing on a touch screen and achieves a high level of manipulation accuracy.

2. Description of the Related Art

A capacitive touch screen is a curved or flat glass substrate coated with a transparent metal oxide. A voltage is applied to the corners of the overlay creating a minute uniform electric field. A bare finger draws current from each corner of the electric field, creating a voltage drop that is measured to determine touch location.

A capacitive touch screen has a transmittance much higher than a resistive touch screen, and can be as high as over 90%. A capacitive touch screen has various advantages. It facilitates to clean the screen with the help of fabric. No unintended command does not harm the screen and does not create hazard to the applications. Further, a capacitive touch screen gives comparatively better image as compared to resistive touch screen. A special feature of capacitive touch screen is that it is only responsive to the human touch. A capacitive touch pen for capacitive touch screen can induce a static electricity on a capacitive touch screen. A conventional capacitive touch screen, as shown in FIG. 1, comprises a conducting shaft 3, and a tip 4 located at the bottom side of the conducting shaft 3. The tip 4 is a conductor simulating a human finger, having a diameter in the range of 5 mm˜6 mm. However, this design of capacitive touch pen is still not satisfactory in function. The writing flexibility of this design of conventional capacitive touch pen needs to be improved. Further, the manipulation accuracy of this design of capacitive touch pen is also poor.

### SUMMARY OF THE INVENTION

The present invention has been accomplished under the circumstances in view. It is the main object of the present invention to provide a capacitive touch pen, which can be elastically deformed to induce an electric field when the user applies a pressure to the tip against the touch screen at the time the tip touches the touch screen, like writing with a real pencil, facilitating writing on a touch screen and achieving a high level of manipulation accuracy.

To achieve this and other objects of the present invention, a capacitive touch pen comprises a shaft, and a tip formed of a multilateral elastic conductor and located at the bottom side of the shaft for touching a touch screen to induce a signal.

### BRIEF DESCRIPTION OF THE DRAWING

FIG. 1 is an elevational view of a conventional touch pen.

FIG. 2 is an elevational view of a capacitive touch pen in accordance with a first embodiment of the present invention.

FIG. 3 is a bottom view of the capacitive touch pen in accordance with the first embodiment of the present invention.

FIG. 4 is a front view of the capacitive touch pen in accordance with the first embodiment of the present invention.

FIG. 5 is a sectional view of the capacitive touch pen in accordance with the first embodiment of the present invention.

FIG. 6 is an enlarged view of a part of FIG. 5.

FIG. 7 is an elevational view of a capacitive touch pen in accordance with a second embodiment of the present invention.

FIG. 8 is a bottom view of the capacitive touch pen in accordance with the second embodiment of the present invention.

FIG. 9 is a front view of the capacitive touch pen in accordance with the second embodiment of the present invention.

FIG. 10 is a sectional view of the capacitive touch pen in accordance with the second embodiment of the present invention.

FIG. 11 is an enlarged view of a part of FIG. 10.

FIG. 12 is an elevational view of a capacitive touch pen in accordance with a third embodiment of the present invention.

FIG. 13 is a bottom view of the capacitive touch pen in accordance with the third embodiment of the present invention.

FIG. 14 is a front view of the capacitive touch pen in accordance with the third embodiment of the present invention.

FIG. 15 is a sectional view of the capacitive touch pen in accordance with the third embodiment of the present invention.

FIG. 16 is an enlarged view of a part of FIG. 15.

FIG. 17 is an elevational view of a capacitive touch pen in accordance with a fourth embodiment of the present invention.

FIG. 18 is a bottom view of the capacitive touch pen in accordance with the fourth embodiment of the present invention.

FIG. 19 is a front view of the capacitive touch pen in accordance with the fourth embodiment of the present invention.

FIG. 20 is a sectional view of the capacitive touch pen in accordance with the fourth embodiment of the present invention.

FIG. 21 is an enlarged view of a part of FIG. 5.

FIG. 22 is an elevational view of a capacitive touch pen in accordance with a fifth embodiment of the present invention.

FIG. 23 is a bottom view of the capacitive touch pen in accordance with the fifth embodiment of the present invention.

FIG. 24 is a front view of the capacitive touch pen in accordance with the fifth embodiment of the present invention.

FIG. 25 is a sectional view of the capacitive touch pen in accordance with the fifth embodiment of the present invention.

FIG. 26 is an enlarged view of a part of FIG. 25.

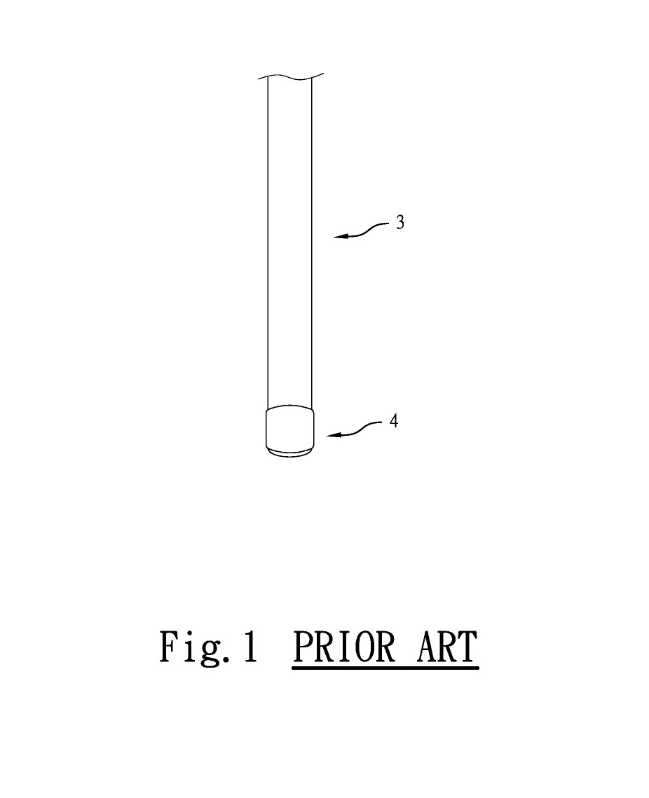

### DETAILED DESCRIPTION OF THE INVENTION

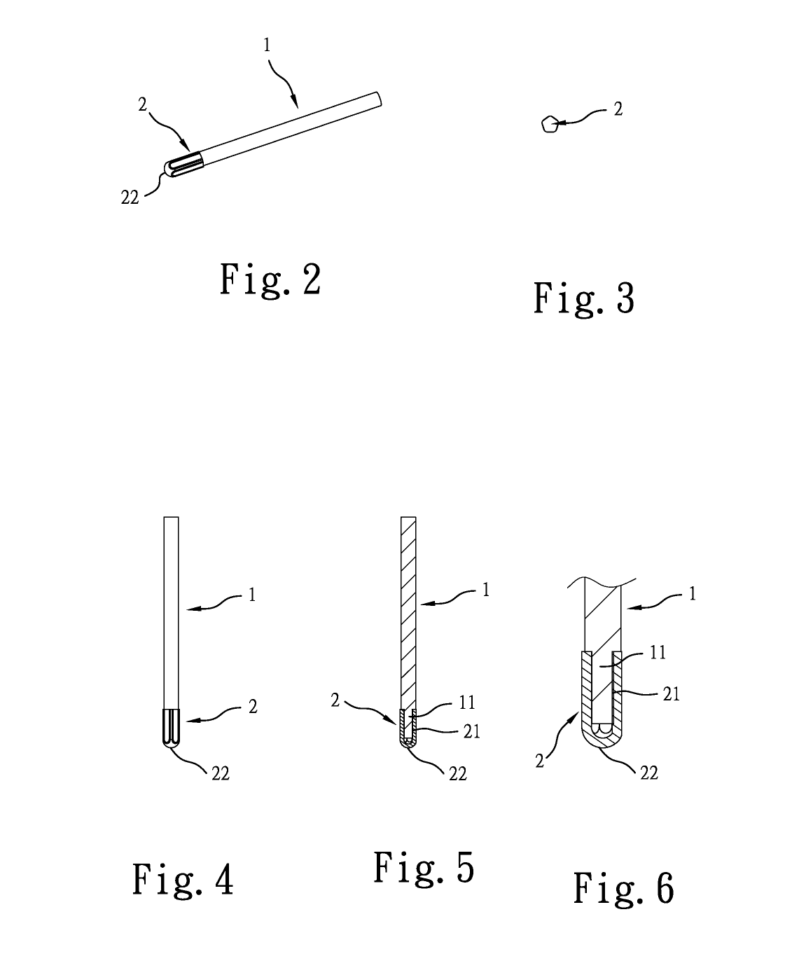

Referring to FIGS. 2-6, a capacitive touch pen in accordance with a first embodiment of the present invention is shown comprising a shaft 1 and a tip 2 connected to the bottom side of the shaft 1.

The tip 2 is a multilateral elastic conductor (see FIGS. 2 and 3). When using the capacitive touch pen to touch a touch screen, the multilateral elastic conductor of the tip 2 is moved to touch the touch screen. When the user applies a pressure to the tip 2 against the touch screen at the time the tip touches the touch screen, like writing with a real pencil, the tip 2 will be elastically deformed to induce an electric field. Further, the user can move the elastically deformed tip 2 on the surface of the touch screen smoothly.

Preferably, the tip 2 has the maximum width in the range of 2.5 mm˜4 mm, improving the manipulation accuracy of the touch pen.

Further, the tip 2 defines therein a locating hole 21 (see FIGS. 5 and 6) for receiving a bottom positioning portion 11 of the shaft 1.

Further, the tip 2 has a rounded portion 22 at the bottom side of the multilateral elastic conductor.

Further, the tip 2 is made of an elastic conducting material in a single piece.

Further, the tip 2 can be made of a non-conducting elastic material and coated with a layer of conducting material.

Further, the shaft 1 can be made of a conducting material, or a non-conducting material coated with a layer of conducting material.

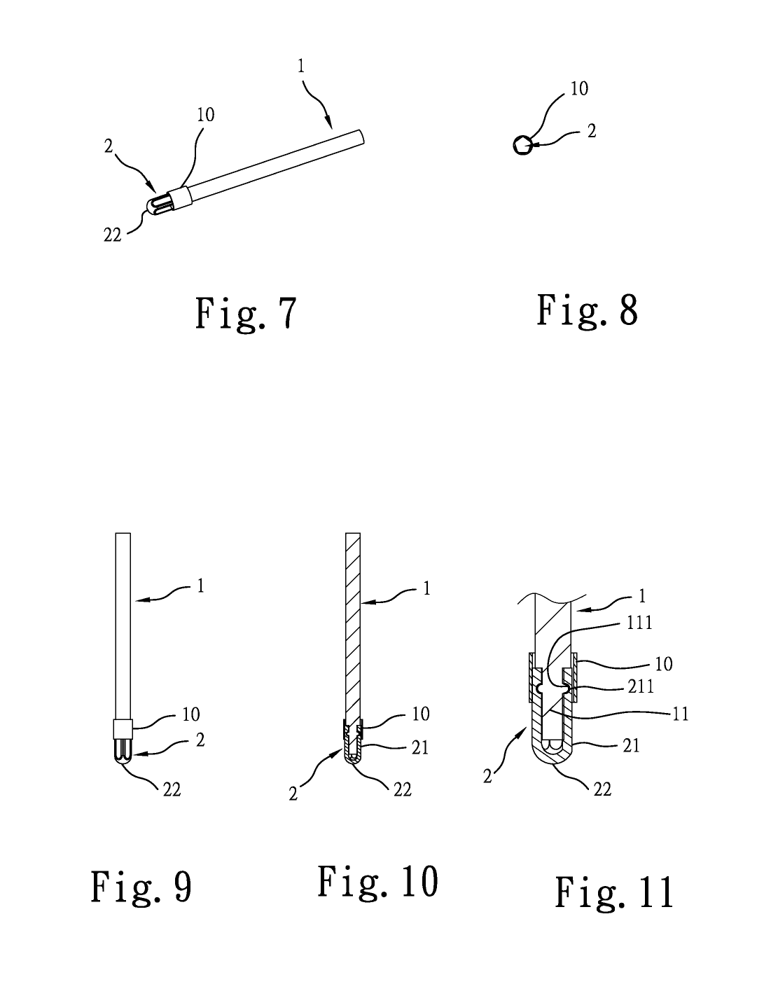

FIGS. 7-11 illustrate a capacitive touch pen in accordance with a second embodiment of the present invention. Similar to the aforesaid first embodiment, the touch pen in accordance with this second embodiment also comprises a shaft 1 and a tip 2 connected to the bottom side of the shaft 1, wherein the shaft 1 comprises a bottom positioning portion 11, and a locating rib 111 extending around the periphery of the bottom positioning portion 11; the tip 2 is a multilateral elastic conductor comprising a rounded portion 22 at the bottom side thereof, a locating hole 21, which accommodates the bottom positioning portion 11 of the shaft 1, and a locating groove 211 disposed in the locating hole 21 and forced into engagement with the locating rib 111 of the shaft 1.

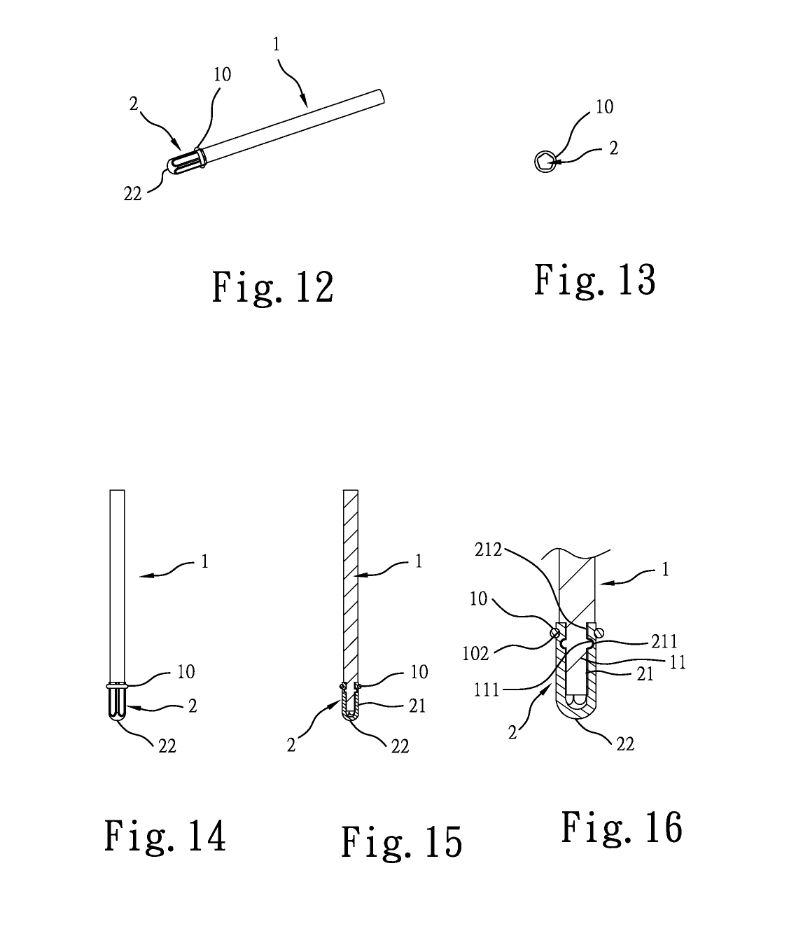

FIGS. 12-16 illustrate a capacitive touch pen in accordance with a third embodiment of the present invention. Similar to the aforesaid first embodiment, the touch pen in accordance with this third embodiment also comprises a shaft 1, a tip 2 attached to the bottom side of the shaft 1, wherein the shaft 1 comprises a bottom positioning portion 11, and a locating rib 111 extending around the periphery of the bottom positioning portion 11; the tip 2 is a multilateral elastic conductor comprising a rounded portion 22 at the bottom side thereof, a locating hole 21, which accommodates the bottom positioning portion 11 of the shaft 1, and a locating groove 211 disposed in the locating hole 21 (see FIG. 16) and forced into engagement with the locating rib 111 of the shaft 1. This third embodiment further comprises a retaining ring 10 fastened to the tip 2 by riveting, gluing or press-fitting to enhance connection tightness between the shaft 1 and the tip 2. The retaining ring 10 has an inner locating rib 102 extending around the inner perimeter thereof (see FIG. 16) and engaged into an outer locating groove 212 around the outer perimeter of the tip 2.

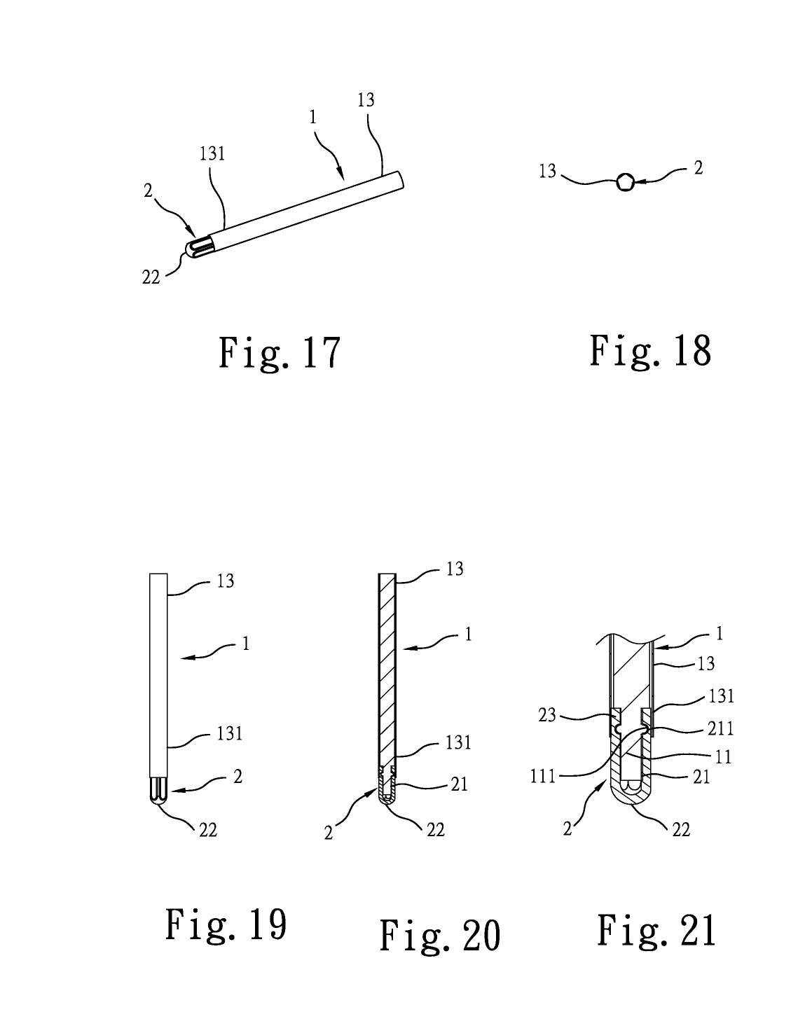

FIGS. 17-21 illustrate a capacitive touch pen in accordance with a fourth embodiment of the present invention. Similar to the aforesaid first embodiment, the touch pen in accordance with this fourth embodiment also comprises a shaft 1, a tip 2 attached to the bottom side of the shaft 1, wherein the shaft 1 comprises a bottom positioning portion 11, and a locating rib 111 extending around the periphery of the bottom positioning portion 11; the tip 2 is a multilateral elastic conductor comprising a rounded portion 22 at the bottom side thereof, a locating hole 21, which accommodates the bottom positioning portion 11 of the shaft 1, and a locating groove 211 disposed in the locating hole 21 (see FIG. 16) and forced into engagement with the locating rib 111 of the shaft 1. This fourth embodiment further comprises a sleeve 13 (see FIG. 21) sleeved onto the shaft 1 with a lower part 131 thereof surrounding an upper part 23 of the tip 2 to enhance connection tightness between the shaft 1 and the tip 2.

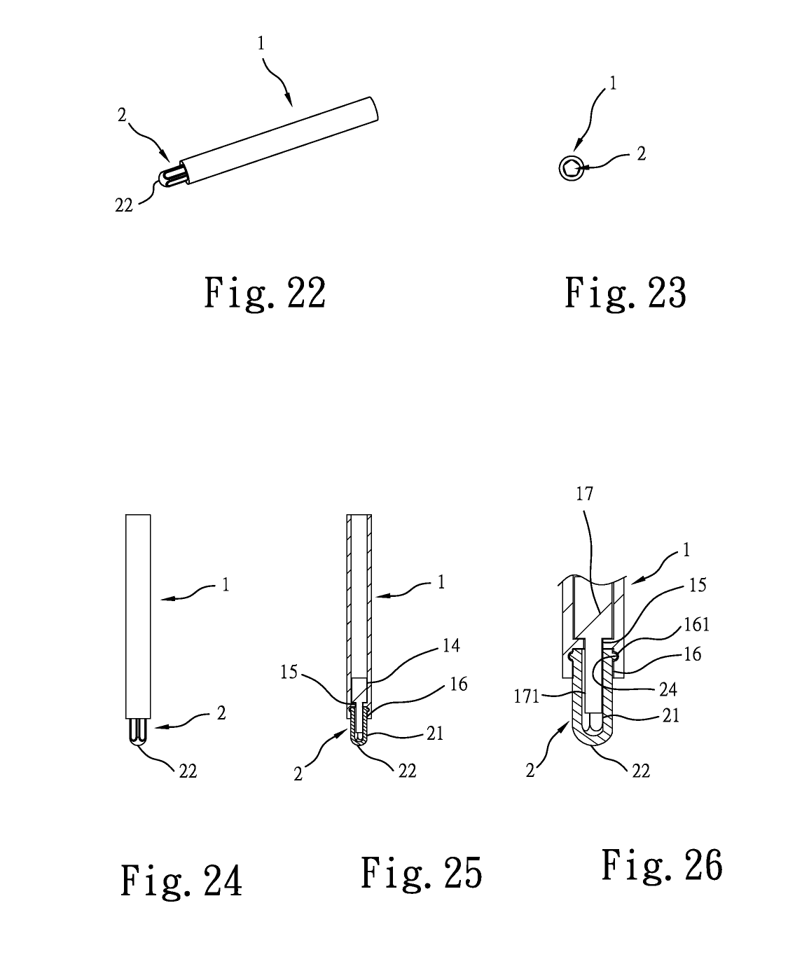

FIGS. 22-26 illustrate a capacitive touch pen in accordance with a fifth embodiment of the present invention. Similar to the aforesaid first embodiment, the touch pen in accordance with this fifth embodiment also comprises a shaft 1, a tip 2 attached to the bottom side of the shaft 1. The main features of this fifth embodiment are outlined hereinafter. The shaft 1 comprises an upper mounting hole 14 and a lower mounting hole 16 defined in the bottom side thereof at different elevations, a locating groove 161 formed in the inner perimeter thereof in the lower mounting hole 16, and a neck hole 15 defined therein in communication between the upper mounting hole 14 and the lower mounting hole 16, a plug member 17 mounted in the upper mounting hole 14 and having a bottom plug portion 171 extending downwardly through the neck hole 15 into the lower mounting hole 16. The tip 2 is press-fitted into the lower mounting hole 16, comprising a locating hole 21, which is forced into engagement with the bottom plug portion 171 of the plug member 17, and a locating rib 24 extending around the periphery thereof and forced into engagement with the locating groove 161 of the shaft 1.

In conclusion, the invention provides a capacitive touch pen with the tip thereof made of a multilateral elastic conductor. When using the capacitive touch pen to touch a touch screen, the user simply needs to apply a pressure to the tip against the touch screen like writing with a real pencil, and the tip will be elastically deformed to induce an electric field. Further, the user can move the elastically deformed tip on the surface of the touch screen smoothly, achieving a high level of manipulation accuracy.

While only few embodiments of the present invention have been shown and described, it will be understood that various modifications and changes could be made thereunto without departing from the spirit and scope of the invention disclosed.

What is claimed is:

1. A capacitive touch pen, comprising a shaft, and a tip located at a bottom side of said shaft for touching a touch screen to induce a signal, wherein said tip is a multilateral elastic conductor.

2. The capacitive touch pen as claimed in claim 1, wherein said tip has the maximum width in the range of 2.5 mm˜4 mm.

3. The capacitive touch pen as claimed in claim 1, wherein said tip is selectively made of an elastic conducting material in a single piece, or an elastic non-conducting material coated with a layer of a conducting material.

4. The capacitive touch pen as claimed in claim 1, wherein said shaft is selectively made of a conducting material, or a non-conducting material coated with a layer of a conducting material.

5. The capacitive touch pen as claimed in claim 1, wherein said tip comprises therein a locating hole; said shaft comprises a bottom positioning portion press-fitted into said locating hole of said tip.

6. The capacitive touch pen as claimed in claim 1, wherein said tip further comprises a locating groove located at an inner perimeter thereof in said locating hole; said shaft comprises further comprises a locating rib extending around the bottom positioning portion thereof and forced into engagement with said locating groove of said tip.

7. A capacitive touch pen, comprising a shaft, and a tip located at a bottom side of said shaft for touching a touch screen to induce a signal, wherein said tip is a multilateral elastic conductor comprising a locating hole and a locating groove extending around an inner perimeter thereof in said locating hole; said shaft comprises a bottom positioning portion press-fitted into said locating hole, and a locating rib extending around the periphery of said bottom positioning portion and forced into engagement with said locating groove of said tip.

8. The capacitive touch pen as claimed in claim 7, further comprising a retaining ring fastened to said tip to secure said tip and said shaft together.

9. The capacitive touch pen as claimed in claim 7, wherein said tip has the maximum width in the range of 2.5 mm˜4 mm.

10. The capacitive touch pen as claimed in claim 7, wherein said tip comprises a rounded portion located at a bottom side thereof.

11. The capacitive touch pen as claimed in claim 7, wherein said tip is selectively made of an elastic conducting material in a single piece, or an elastic non-conducting material coated with a layer of a conducting material.

12. The capacitive touch pen as claimed in claim 7, wherein said shaft is selectively made of a conducting material, or a non-conducting material coated with a layer of a conducting material.

13. The capacitive touch pen as claimed in claim 8, wherein said retaining ring comprises an inner locating rib extending around an inner perimeter thereof; said tip comprises an outer locating groove extending around an outer perimeter thereof and forced into engagement with said inner locating rib of said retaining ring.

14. The capacitive touch pen as claimed in claim 7, further comprising a sleeve sleeved onto said shaft over a part of said tip.

15. A capacitive touch pen, comprising a shaft, and a tip located at a bottom side of said shaft for touching a touch screen to induce a signal, wherein said tip is a multilateral elastic conductor comprising a locating hole; said shaft comprises a plug member located at a bottom side thereof and fastened to said locating hole of said tip.

16. The capacitive touch pen as claimed in claim 15, wherein said shaft comprises an upper mounting hole and a lower mounting hole defined in the bottom side thereof at different elevations, and a neck hole defined therein in communication between said upper mounting hole and said lower mounting hole; said plug member is mounted in said upper mounting hole and having a bottom plug portion extending downwardly through said neck hole into said lower mounting hole; said tip is press-fitted into said lower mounting hole of said shaft to force the locating hole thereof into engagement with said bottom plug portion of said plug member.

17. The capacitive touch pen as claimed in claim 15, wherein said shaft further comprises a locating groove formed in an inner perimeter thereof in said lower mounting hole; said tip further comprises a locating rib extending around an outer perimeter thereof and forced into engagement with said locating groove in said lower mounting hole of said shaft.

18. The capacitive touch pen as claimed in claim 15, wherein said tip has the maximum width in the range of 2.5 mm˜4 mm.

19. The capacitive touch pen as claimed in claim 15, wherein said tip comprises a rounded portion located at a bottom side thereof.

20. The capacitive touch pen as claimed in claim 15, wherein said tip is selectively made of an elastic conducting material in a single piece, or an elastic non-conducting material coated with a layer of a conducting material; said shaft is selectively made of a conducting material, or a non-conducting material coated with a layer of a conducting material.
